(19) United States
(12) Patent Application Publication
(10) Pub. No.: US 2017/0042648 A1
(43) Pub. Date: Feb. 16, 2017

(54) ELECTRIC BRUSH DEVICE AND METHOD

(71) Applicant: AIRWAY MEDIX SPOLKA Z.O.O., Warszawa (PL)

(72) Inventors: Oron ZACHAR, Tel Aviv (IL); Elad EINAV, Salit (IL)

(21) Appl. No.: 15/097,507

(22) Filed: Apr. 13, 2016

Related U.S. Application Data
(60) Provisional application No. 62/146,944, filed on Apr. 13, 2015.

(51) Int. Cl. A61C 17/02; A46B 9/04; A61C 17/36; A46B 5/00; A61C 17/22; A61C 17/28

(52) U.S. Cl. CPC A61C 17/0208; A61C 17/222; A61C 17/227; A61C 17/28; A61C 17/36; A46B 5/0095; A46B 9/04

(57) ABSTRACT

Embodiments of the invention relate to a brush-head assembly for a brush device, the brush head assembly comprising: a. an elongate body having proximal and distal ends and defining a elongate axis; and b. a brush disposed mounted onto the elongate body; c. a fluid-delivery lumen disposed within the elongate body along the elongate axis thereof; and d. a suction lumen having first and second portions, the first portion disposed within the elongate body along the elongate axis thereof, the second portion disposed at the proximal end of and in fluid communication with the first portion.

### CROSS REFERENCE TO RELATED APPLICATIONS

This application claims priority to U.S. provisional application 62146944 filed on Apr. 13, 2015 which is incorporated herein by reference in its entirety.

### FIELD OF THE INVENTION

The present disclosure relates to apparatus and methods for oral care.

### SUMMARY OF EMBODIMENTS

It is now disclosed a brush-head assembly for a brush device, the brush head assembly comprising: a. an elongate body having proximal and distal ends and defining a elongate axis; b. a brush disposed mounted onto the elongate body; c. a fluid-delivery lumen disposed within the elongate body along the elongate axis thereof; and d. a suction lumen having first and second portions, the first portion disposed within the elongate body along the elongate axis thereof, the second portion disposed at the proximal end of and in fluid communication with the first portion, at least some of the second portion protruding sideways from the elongate body to form an elongate-body-external portion of the suction lumen.

It is now disclosed a brush-head assembly for a brush device, the brush head assembly comprising: a. an elongate body having proximal and distal ends and defining a elongate axis; and b. a brush disposed mounted onto the elongate body; c. a fluid-delivery lumen disposed within the elongate body along the elongate axis thereof; and d. a suction lumen having first and second portions, the first portion disposed within the elongate body along the elongate axis thereof, the second portion disposed at the proximal end of and in fluid communication with the first portion, at least some of the second portion forming an elongate-body-external portion of the suction lumen.

It is now disclosed a system comprising: a. a brush head assembly; and b. a base detachably attachable to the brush head, wherein the brush head assembly comprises: i. an elongate body having proximal and distal ends and defining a elongate axis; and ii. a brush disposed mounted onto the elongate body; iii. a fluid-delivery lumen disposed within the elongate body along the elongate axis thereof; and iv. a suction lumen having first and second portions, the first portion disposed within the elongate body along the elongate axis thereof, the second portion disposed at the proximal end of and in fluid communication with the first portion, at least some of the second portion forming an elongate-body-external portion of the suction lumen, wherein the elongate-body-external portion of the suction lumen is attached to an outside of the base.

In some embodiments, the brush is disposed in a distal region of the elongate body.

In some embodiments, further comprising a base portion detachably attachable to the brush-head assembly, an attachment mechanism configured to detachably attach the second portion of the suction lumen to an exterior of the base portion.

In some embodiments, further comprising an electric motor mounted on or disposed within the elongate body.

In some embodiments, further comprising an electric motor mounted on or disposed within the elongate body, wherein the electric motor is configured to vibrate and/or rotate the brush head and the electric motor is at least one of (i) displaced from the brush by at most 1 cm and (ii) disposed in a distal region of the elongate body.

In some embodiments, the electric motor is permanently mounted on or disposed within the brush head.

In some embodiments, further comprising an electric connector configured to deliver external electric power.

In some embodiments, the electric connector runs along the elongate axis and/or a proximal end of the electric connector is on a proximal side of the brush head assembly.

It is now disclosed a system for cleaning the oral cavity, the system comprising: a. a brush head; b. a base detachably attachable to the brush head; c. a brush disposed in a distal region of the brush-head; d. a fluid-delivery lumen disposed within the elongate body along the elongate axis thereof; f. a first electric motor configured to vibrate and/or rotate the brush, the first electric motor mounted on or disposed within the brush head; e. a fluid reservoir disposed on or within the base; and g. a second electric motor mounted on or disposed within the base, the second electric motor being configured to expel the fluid from the reservoir so that the expelled fluid enters the fluid-delivery lumen, passes through the fluid-delivery lumen and exits a distal orifice thereof.

In some embodiments, the electric motor operates an actuator and/or press element and/or plunger to apply a force upon the fluid within the reservoir to expel the fluid from the reservoir.

In some embodiments, further comprising an onboard electrical power source located on or within the base, and an electric connector electrically connecting the first electric motor to the electrical power source.

In some embodiments, the first and second electrical motors are both electrically connected to a common power source.

In some embodiments, the first electric motor is mounted to the brush head assembly in the distal region thereof.

In some embodiments, further comprising: h. a suction lumen, at least a portion of which is disposed within the elongate body along the elongate axis thereof.

In some embodiments, a width of the fluid-delivery lumen is at most 75%, or at most 50%, or at most 40% that of the suction lumen.

In some embodiments, a ratio between: i. a width of the suction lumen; and ii. a width of the fluid-delivery lumen is at least 1.5 or at least 2 or at least 3.

In some embodiments, i. a width of a distal orifice of the suction lumen; and ii. a width of a distal orifice of the fluid-delivery lumen is at least 1.5 or at least 2 or at least 3.

In some embodiments, a displacement between respective centroids of a distal orifice of the suction lumen and a distal orifice of the fluid-delivery lumen is at most 1 cm or at most 5 mm or at most 3 mm.

In some embodiments, a center of a distal orifice of the suction lumen is located in position on the brush head that is distal relative a distal orifice of the fluid-delivery lumen.

In some embodiments, further comprising a tapered connector at a distal end of the suction lumen.

In some embodiments, the brush head assembly is sideways bendable and/or flexible.

In some embodiments, a ratio between (i) a width of a cross section of the elongate body and/or brush head assembly; and (ii) a width of the base is at most 0.8 or at most 0.7 or at most 0.6 or at most 0.5. In some embodiments, any electric motor is a DC motor.

### BRIEF DESCRIPTION OF THE DRAWINGS

FIGS. 1A-1D and 2-5 illustrate oral-care devices according to some embodiments of the invention

### DETAILED DESCRIPTION OF EMBODIMENTS

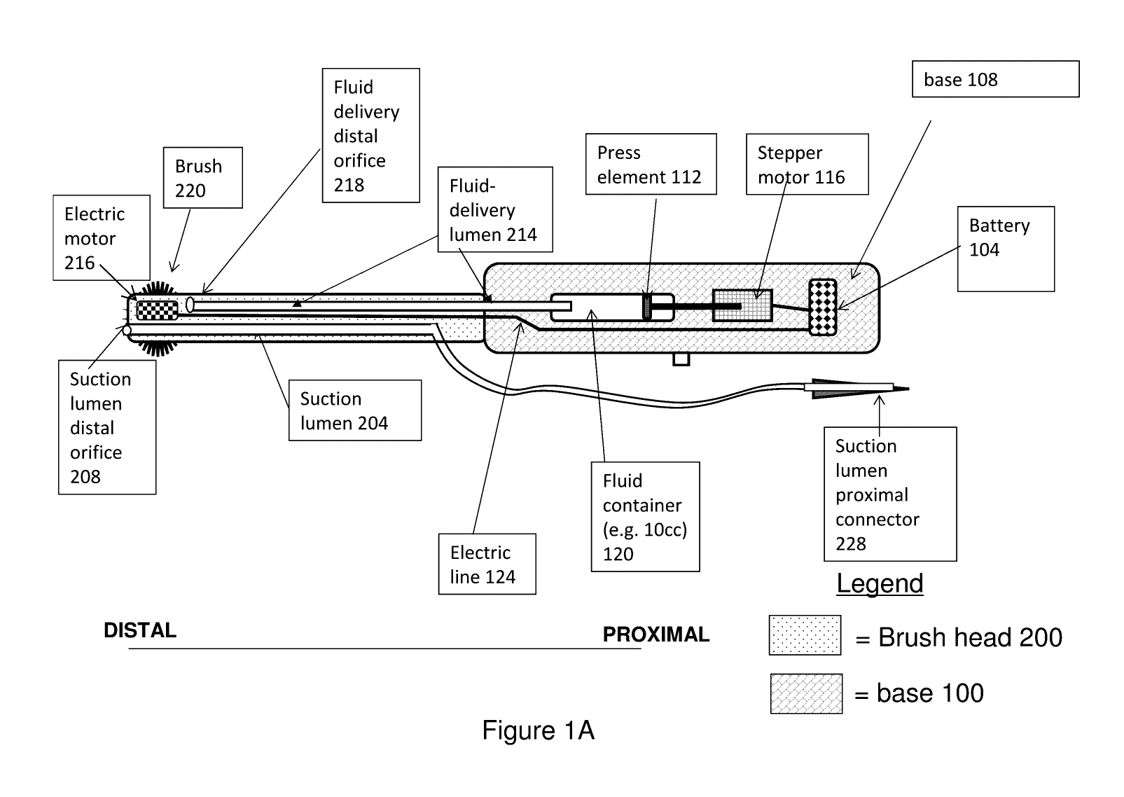

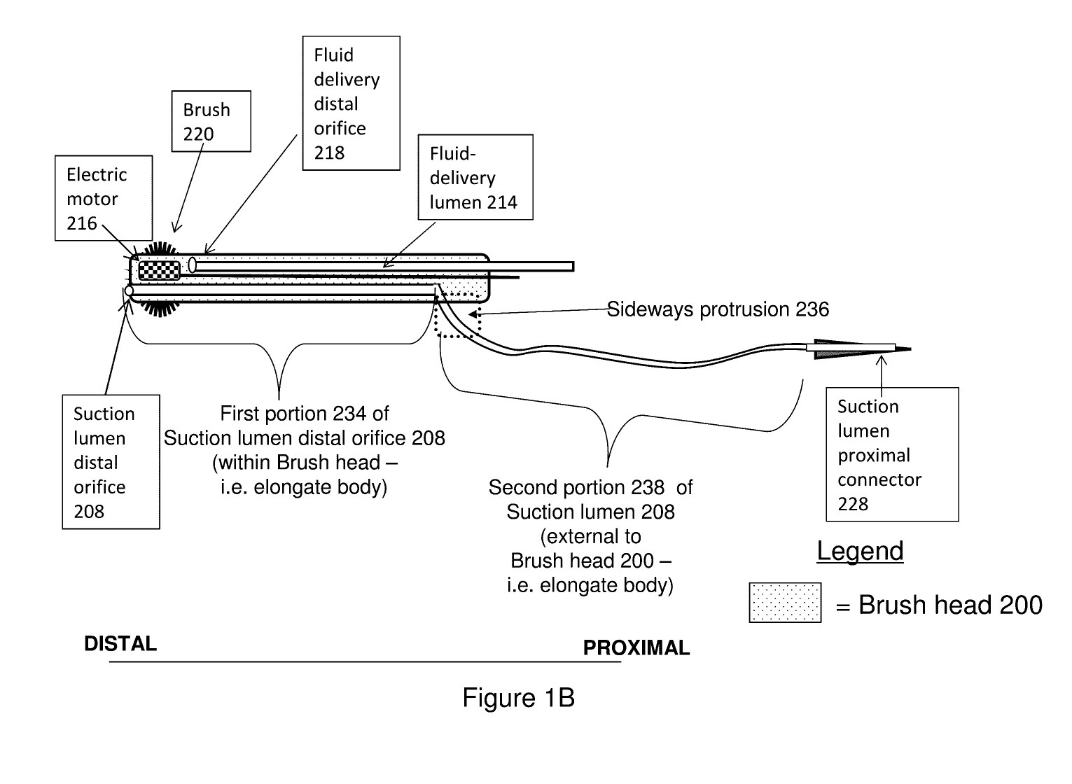

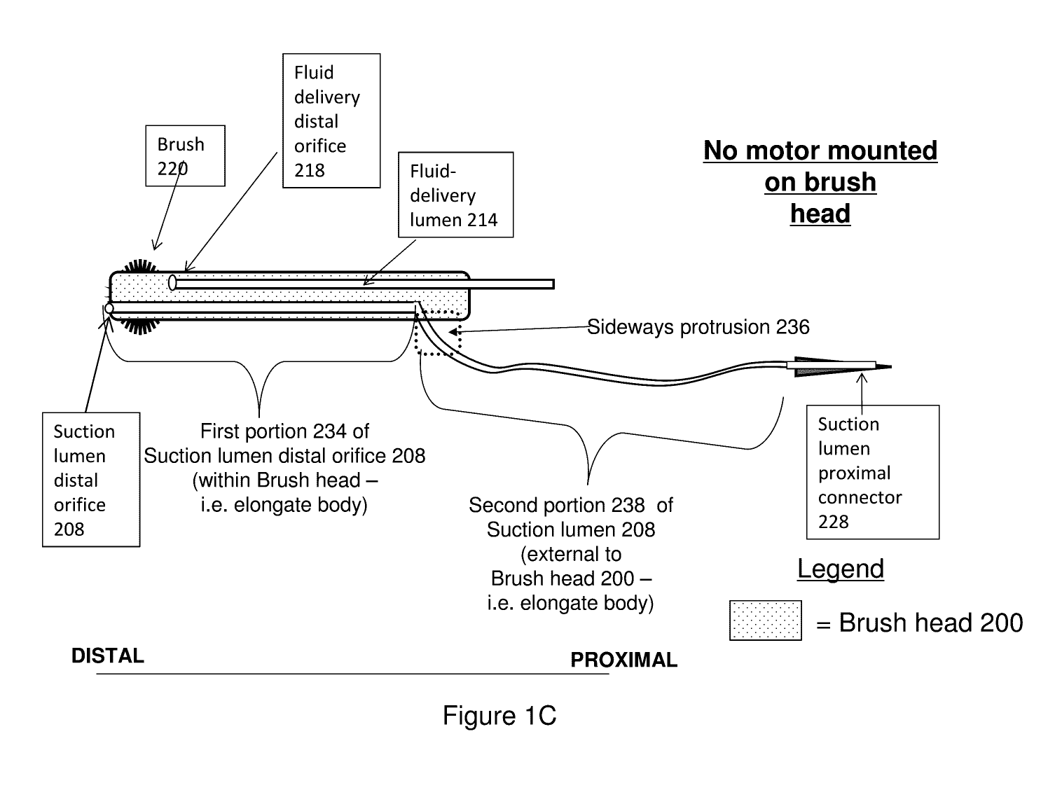

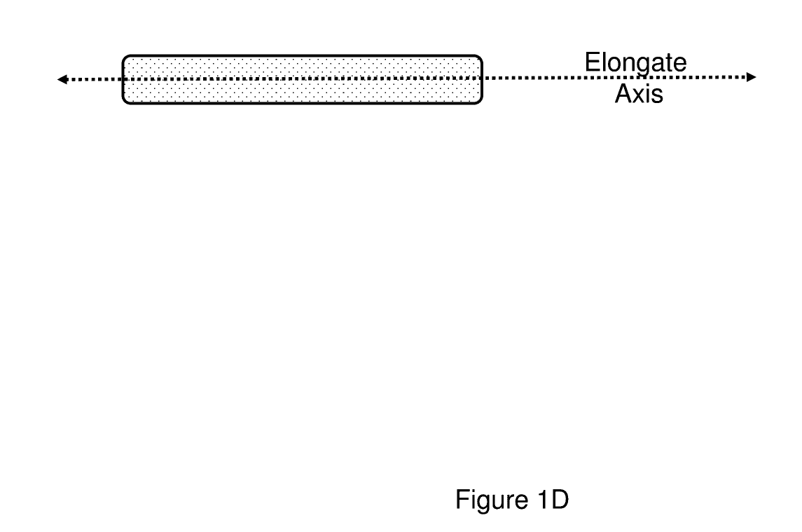

FIG. 1A illustrates an oral-care device (e.g. for brushing teeth) according to some embodiments of the invention. In some embodiments, the device includes (i) base portion 100 and (ii) brush-head portion 200—for example, attachable (e.g. detachably attachable) to each other. Brush-head portion 200 comprises an elongate body defining an elongate axis (see FIG. 1D). In different embodiments, the elongate body has (i) a length of at least 5 cm and/or at most 25 cm and/or (ii) a thickness of at most 2 cm or at most 1 cm and/or at least 0.5 cm. Various features of the ‘brush head’ or ‘brush head assembly’ described herein may, in fact, be features of the elongate body.

In different embodiments, the device comprises at least one or at least two or all three of the following: (i) a brush 220 (e.g. including an array of bristles—for example, similar to those of any toothbrush—e.g. similar to any electric toothbrush) ; (ii) a fluid-delivery lumen 214 having a suction-lumen orifice 218 at a distal end thereof and (iii) a suction lumen 204 having a suction-lumen orifice 208 at a distal end thereo.

In some embodiments, the brush and/or suction-lumen orifice 218 and/or fluid-delivery orifice is located within a distal region of the elongate body—e.g. in the distal-most 20% of elongate body and/or within 3 cm or within 2 cm or within 1 cm of distal tip of the elongate body.

In some embodiments, during operation of the device, a source of negative pressure (NOT SHOWN) is applied to a proximal end of the suction lumen (e.g. via proximal connector 228 disposed at a proximal end of suction lumen 204—e.g. a tapered connector). Matter within the subject's oral cavity is suctioned into the suction-lumen 204 via suction lumen distal orifice 208 and is transported in a proximal direction within suction-lumen 204—e.g. out of the oral cavity. Alternatively or additionally, during operation, fluid is distally forced through the fluid-delivery lumen and expelled via fluid-delivery orifice 218—e.g. as a jet of fluid. For example, a reservoir of fluid 120 is located within base 100. For example, a press element 112 and/or plunger 112

In some embodiments, using a motor 116 to force fluid through fluid delivery lumen 214 is useful for providing a steady flow rate of fluid through lumen—this may be useful, e.g. in an intensive care situation.

Operation of the brush may dislodge matter within the subject's oral cavity from locations on or between the subject's teeth or from locations on or within the subject's gums. Flow of fluid (e.g. as a jet of fluid) into the oral cavity may also dislodge matter within the subject's oral cavity. Matter within the subject's oral cavity may be suctioned out of the oral cavity via the suction lumen 204.

In different embodiments, operation of an electric motor 216 causes movement (e.g. rotational and/or vibrational movement) of brush 220 and/or of bristles thereof - e.g. useful for dislodge matter from teeth and/or gums.

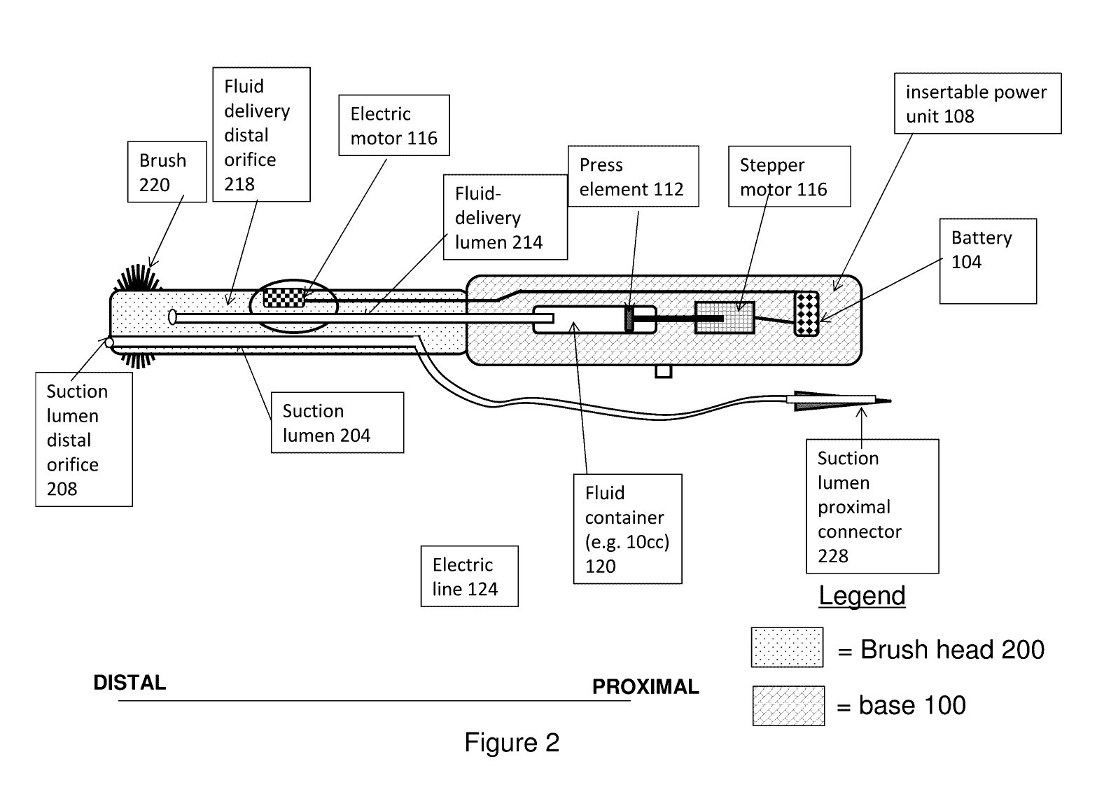

In one non-limiting example, motor 216 and brush 220 are mechanically coupled via a shaft (NOT SHOWN in FIG. 1A) and brush 220 rotates around a central axis of the shaft (i.e. into the page). As shown in FIGS. 1-5, electric motor 216 may be located at different locations. In the example of FIG. 1A, electric motor 216 is deployed at a distal end of the brush head 200—e.g. immediately adjacent to brush 220. In the example of FIG. 2, electric motor is mounted to brush head 200 but is located towards further away from brush 220 than the example of FIG. 1—in the example of FIG. 2, motor 216 is located in a middle portion of the brush head 200.

In some embodiment, electric motor 116 is permanently attached to (e.g. mounted to and/or disposed within) brush head 200. Thus, in some embodiments, electric motor 116 may serve as part of a ‘replacement cartridge’—an ‘old’ brush head including a first electric motor permanently mounted thereto may be replaced by a ‘new’ brush head including a second electric motor permanently mounted thereto.

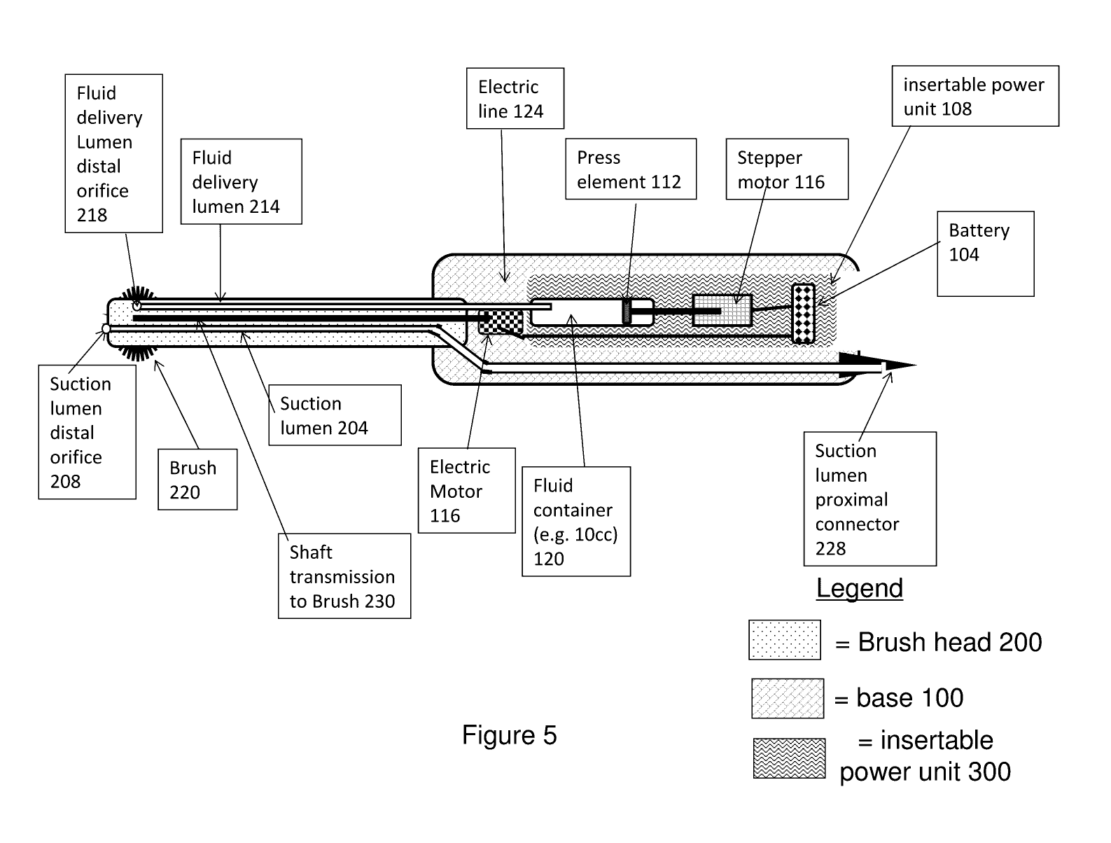

However, as illustrated in FIG. 5, in some embodiments electric motor 216 is not permanently mounted to the base 200, or even mounted to base 200—in the example of

FIG. 5, electric motor 216 is mounted to the base 100, and causes brush 220 to rotate via shaft transmission 230. In another example (NOT SHOWN), electric motor is mounted to the base 100, and causes brush 220 (i.e. at least bristles thereof) to vibrate—i.e. vibrations produced in base 100 propagate through brush head 200 along an elongate axis thereof.

In some embodiments, fluid is forced through fluid delivery lumen in a distal direction. For example, fluid (e.g. cleaning fluid and/or water and/or any aqueous solution) may be stored within container (or reservoir) 120 and forced through the fluid-delivery lumen 214—e.g. to form a jet of fluid exiting fluid delivery lumen distal orifice 218. For example, a second electrical motor (e.g. a stepper motor 116) expel (e.g. by operating an actuator and/or pressing element and/or plunger) fluid resident within fluid container/reservoir 120—the expelled fluid enters into fluid-delivery lumen (e.g. via a proximal end thereof), passes through the fluid-delivery lumen 214, and exits the fluid delivery lumen via the distal orifice 218 thereof (e.g. as a jet of fluid).

In some embodiments, motor 216 receives electrical power from a power source (e.g. battery 104) that is ‘external’ to the fluid head portion - e.g from a power source mounted on or disposed in base 100—e.g. within base 100. For example, the electrical current flows to motor 216 via electric line 124. In some embodiments, engaging base 100 to the brush head 200 serves to bring motor 216 in electrical contact with its power source (e.g. battery 104).

In different embodiments, a diameter of suction lumen is at least 1 mm and/or at most 3 mm (e.g. at most 2 mm). In some embodiments, a diameter of fluid-delivery lumen is at most.

FIG. 1B illustrates the brush head assembly 200 of the system of FIG. 1A. As shown in FIG. 1B, suction lumen 204 includes two portions: (i) a first portion 234 within the head 200 (i.e. within elongate body) and along an elongate axis thereof; (ii) a second portion 238 that is external to the elongate body (and to head 200). In the example of FIG. 1B, this second portion is external to base 100. As shown in FIG. 1A, this second portion exits elongate body and head 200 via a sideways protrusion 236. For example, a proximal connector 228 is connected to the base-external portion 238 of the suction lumen 204.

The brush head assembly of FIG. 1B includes a suction lumen which may be said to bypasses the base.

FIG. 1C is similar to FIG. 1B but for systems where the electric motor 216 is not deployed to the brush head—e.g. where the electric motor 216 is not is not deployed to the brush head—e.g. deployed to the base as in FIG. 5.

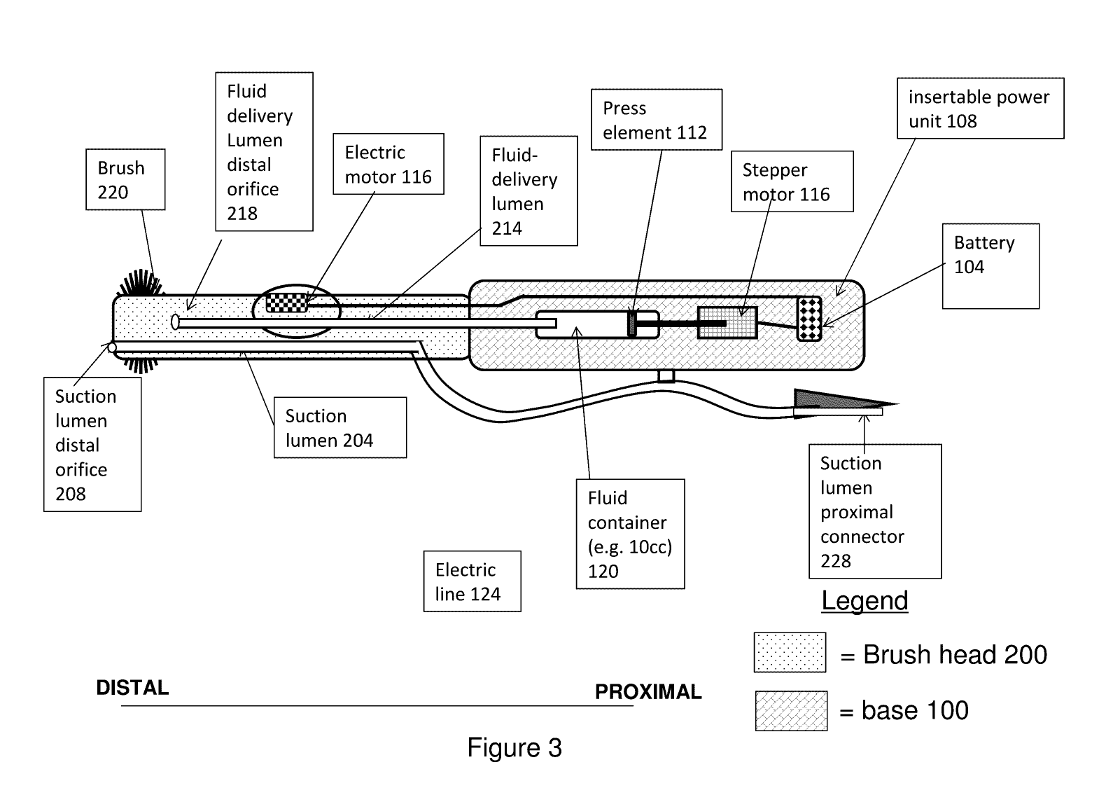

In the example of FIG. 3, base-external portion 238 of the suction lumen is attached to an outer surface (e.g. a surface facing in a ‘sideways’ direction and/or facing in a direction perpendicular to an elongate axis of brush head 200 (or perpendicular to a central axis of base 100)—e.g. reversably attachable. For example, the outer surface of base may include a groove (NOT SHOWN) into which a section (e.g. a ‘short’ section) of base-external portion 238 of the suction lumen may be inerted. In other examples, the attachment may be performed a tape and/or by a clip or in any other manner known in the art.

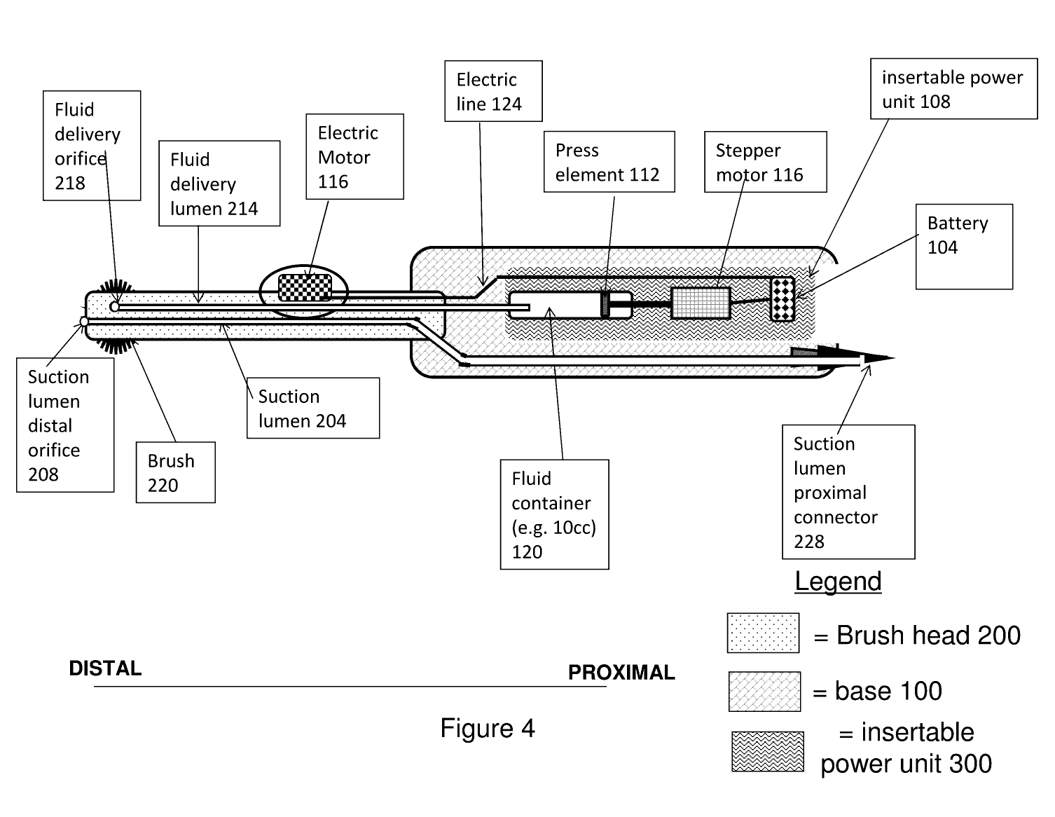

In the example of FIG. 4, base 100 includes two portions: an outer portion and an insertable (e.g. reversably insertable) unit 108.

1. A brush-head assembly for a brush device, the brush head assembly comprising:
a. an elongate body having proximal and distal ends and defining a elongate axis; and
b. a brush disposed mounted onto the elongate body;
c. a fluid-delivery lumen disposed within the elongate body along the elongate axis thereof; and
d. a suction lumen having first and second portions, the first portion disposed within the elongate body along the elongate axis thereof, the second portion disposed at the proximal end of and in fluid communication with the first portion, at least some of the second portion protruding sideways from the elongate body to form an elongate-body-external portion of the suction lumen.

2. A brush-head assembly for a brush device, the brush head assembly comprising:
a. an elongate body having proximal and distal ends and defining a elongate axis; and
b. a brush disposed mounted onto the elongate body;
c. a fluid-delivery lumen disposed within the elongate body along the elongate axis thereof; and
d. a suction lumen having first and second portions, the first portion disposed within the elongate body along the elongate axis thereof, the second portion disposed at the proximal end of and in fluid communication with the first portion, at least some of the second portion forming an elongate-body-external portion of the suction lumen.

3. A system comprising:
a. a brush head assembly; and
b. a base detachably attachable to the brush head, wherein the brush head assembly comprises:
i. an elongate body having proximal and distal ends and defining a elongate axis; and
ii. a brush disposed mounted onto the elongate body;
iii. a fluid-delivery lumen disposed within the elongate body along the elongate axis thereof; and
iv. a suction lumen having first and second portions, the first portion disposed within the elongate body along the elongate axis thereof, the second portion disposed at the proximal end of and in fluid communication with the first portion, at least some of the second portion forming an elongate-body-external portion of the suction lumen, wherein the elongate-body-external portion of the suction lumen is attached to an outside of the base.

4-25. (canceled)
